(19) United States
(12) Patent Application Publication
(10) Pub. No.: US 2005/0052609 A1
(43) Pub. Date: Mar. 10, 2005

(54) Multi-wavelength external-cavity laser with digital and mode-hope-free fine tuning mechanisms

(76) Inventors: Ci-Ling Pan, Hsinchu (TW); Ru-Pin Chao, Hsinchu (TW); Yu-Ping Lan, Chu-tung (TW)

Correspondence Address: PERKINS COIE LLP, P.O. BOX 2168, MENLO PARK, CA, 94026, US

(21) Appl. No.: 10/738,893

(22) Filed: Dec. 16, 2003

(30) Foreign Application Priority Data
Sep. 10, 2003 (TW) 092124960

(51) Int. Cl. G02F 1/13

(52) U.S. Cl. 349/195

(57) ABSTRACT

An apparatus for electronically tuning of a single or multi-wavelength external-cavity laser, comprising: an AR-coated diode laser, a collimator, a liquid crystal cell, a dispersion grating, a focusing lens and a liquid crystal pixel mirror. Wavelength channels can be selected by opening the appropriate pixels of the liquid crystal pixel mirror. By turning on several pixels at the same time, the laser can generate output at several wavelengths. Wavelength switching between channels is also possible. Laser wavelength can further be tuned by varying the driving voltages of the liquid crystal cell or the appropriate pixel mirror. The liquid crystal cell and the liquid crystal pixel mirror in the laser cavity can be combined to form a sandwich-type liquid crystal pixel mirror that allows both step (digital) or fine tuning of the laser wavelength.

### BACKGROUND OF THE INVENTION

1. Field of the Invention

The present invention relates to an electrically tuned multi-wavelength external-cavity laser. In particular, the present invention relates to a liquid crystal cell and a liquid crystal pixel mirror, by controlling the driving voltage of the liquid crystal cell and the liquid crystal pixel mirror, the output wavelength of the laser appropriates to each pixel of the liquid crystal pixel mirror can be tuned.

2. Description of Relative Prior Art

The applications of the laser generating tunable output wavelengths to optical communication, precision measurement, remote sensing and spectroscopy have led to the introduction of its related products.

In the published documents, such as in the articles “A mode hopping suppressed external-cavity semiconductor laser using feedback control”, S. Mattori et al., IEICE. Trans. Electron. E85-C (1) 98(2002), a technology using piezoelectric transducer (PZT) as the tuning device of the external-cavity semiconductor laser. The mechanism of the apparatus is more complicated and the operation voltage is high (couple of volts to hundred volts). PZT also has device-aging problem. In the article “Simple high-coherence rapidly tunable eternal-cavity diode laser”, B. Bogg et al., Optics Letter, 23(24), 1906(1998), and “Single frequency electro-optical tuning of an extended cavity diode laser at 1500 nm wavelength” J-P. Geodgebuer et al., IEEE J. of Quantum Electronics. 28(6), 1414(1992), a technology using electrically control non-linear E-O crystal to tune the wavelength, should be operated at higher voltage. In the article “Continuous tuning of an electrically tunable external-cavity semiconductor laser” M. Kourog et. al., Optics Letters, 25(16), 1165(2000), which is a technology using electrically control non-linear A-O crystal to tune the wavelength, the traveling route is deflected so that operation and adjustment are more difficult. It also required higher operating voltage.

In the U.S. Pat. No. 6,205,159 to Sesko et al., which constitutes the bulk etalon, interference filter and tunable etalon to form a tuning apparatus, wherein ferro-electric liquid crystal is used. Further, several etalons and filter are required, for continuous tuning. The U.S. Pat. No. 6,526,071 to Chapman William et al., the wavelength is selected by using different channel spacing of the two interference devices (bulk or parallel plate etalon and interference filter). In the U.S. Pat. No. US2003/0048816A1 to Emmerich Mueller et al., the wavelength selection method is a traditional mechanical rotational type. In the U.S. Pat. No. US2003/0048817A1 to Wolf Steffens et al., a liquid crystal device is used to transverse optical path variation control. Both of the above two patents make use of typical single wavelength output of external-cavity laser incorporated with a device of controllable optical path change.

What is needed is an improved electrically tuned multi-wavelength external-cavity laser with digital and mode-hope-free fine tune mechanisms, and also needed to have capability of generation of multi-wavelength and continuously tuned wavelength.

### OBJECTS OF THE INVENTION

Therefore, it is an object of the invention to provide an electrically tuned multi-wavelength external-cavity laser, by controlling the driving voltage of the liquid crystal cell and the liquid crystal pixel mirror, the output wavelength of the laser appropriates to each pixel of the liquid crystal pixel mirror can be tuned.

It is another object of the invention to provide an electrically tuned multi-wavelength external-cavity laser, which can be designed to output particular frequency (e.g., according to the ITU grid used in DWDM) to output single or multi-wavelength, and tune the frequency.

It is yet another object of the invention to provide an electrically tuned multi-wavelength external-cavity laser, to simplify the structure of external-cavity semiconductor laser, reduce the requirement of precise adjustment and solve the piezoelectric material aging problem.

### DISCLOSURE OF THE INVENTION

A first aspect of the present invention describes an electrically tuned multi-wavelength external-cavity laser, comprising: an AR-coated diode laser; a collimator, to form a collimated laser beam; a liquid crystal cell, formed by two glass plates and filled with nematic liquid crystal, the two ends are wound with conductive tapes for applying and changing the driving voltage to the liquid crystal cell to tune the output wavelength of the laser; a dispersion grating, to produce diffraction and dispersion of the incident collimated laser beam; a focusing lens, to focus the dispersed light on a liquid crystal pixel mirror; a liquid crystal pixel mirror, formed by two glass plates and filled with twisted nematic liquid crystal, the rubbing direction of the glass plates with ITO pixel pattern are perpendicular to each other; the wavelength of the laser can be switched by switching on-off the driving voltage of the appropriate pixel.

Another preferred embodiment of the present invention describes an electrically tuned multi-wavelength external-cavity laser, comprising: an AR-coated diode laser; a collimator, to form a collimated laser beam; a dispersion grating, to produce diffraction and dispersion of the incident collimated laser beam; a focusing lens, to focus the dispersed light on a liquid crystal pixel mirror; a sandwich-type liquid crystal pixel mirror, formed by a first, a second and a third glass plates and filled with first a layer of homogeneously aligned nematic liquid crystal and second a layer of twisted nematic liquid crystal, the rubbing direction of the back surface of the first glass plate is parallel to the rubbing direction of the front surface of the second glass plate, the rubbing direction of the back surface of the second glass plate which is parallel to the rubbing direction of its front surface is perpendicular to the rubbing direction of the front surface of the third glass plate, both the surfaces of the second glass plate have ITO pixel patterns, every pixel can be electrically controlled, laser wavelength can be tuned by varying the driving voltage applied to the pixel on the front surface of the second glass plate, control each pixel on the back surface of the second glass plate can select the output wavelength of the laser, the back surface of the third glass plate is followed by a polarizer and a high-reflector, e.g., a gold-coating mirror. The beam passed through the device then focusing on the gold reflected mirror, the reflected light coming back along the original path to form oscillation and produce laser output.

### BRIEF DESCRIPTION OF THE DRAWINGS

The foregoing and other advantages of the present invention will be more fully understood by reference to the following detailed description in conjunction with the accompanied drawings wherein:

FIG. 1 shows an electrically tuned multi-wavelength external-cavity laser mechanism according to one embodiment of the present invention.

FIG. 2 shows a liquid crystal cell.

FIG. 3(A) shows a liquid crystal pixel mirror.

FIG. 3(B) shows the ITO pattern of the liquid crystal pixel mirror.

FIG. 4(A) shows the experiment result of the selected output frequencies with 100 GHz spacing.

FIG. 4(B) shows the experiment result of the output of arbitrarily selected three frequencies.

FIG. 5 shows the experiment result of mode-hope-free fine-tuning of frequency.

FIG. 6 illustrates the mechanism of an electrically tuned multi-wavelength external-cavity laser using sandwich-type liquid crystal pixel mirror according to one embodiment of the present invention.

FIG. 7(A) illustrates the composition of the sandwich-type liquid crystal pixel mirror according to one embodiment of the present invention.

FIG. 7(B) shows the liquid crystal cell.

FIG. 7(C) shows the liquid crystal pixel mirror.

### DESCRIPTION OF THE PREFERRED EMBODIMENTS

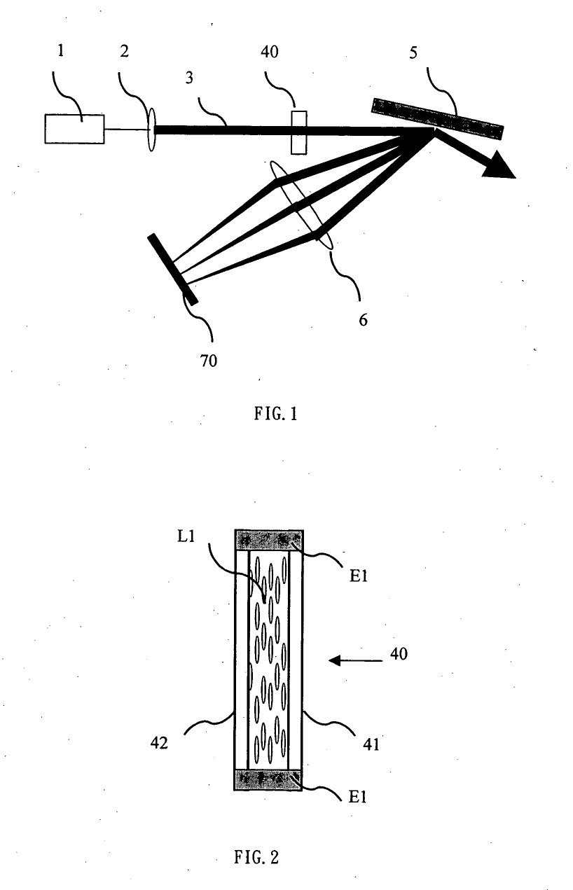

Referring to FIG. 1, FIG. 1 is the mechanism of an electrically tuned multi-wavelength external-cavity laser according to one embodiment of the present invention. The system including: an AR-coated semiconductor diode laser 1, a collimator 2, a liquid crystal cell 40, a dispersion grating 5, a focusing lens 6 and a liquid crystal pixel mirror 70. The light emitted from the semiconductor laser 1 goes through the collimator 2, forms a collimated laser beam 3, laser beam 3 goes through the liquid crystal cell 40 hits the dispersion grating 5, the incident collimated laser beam is diffracted by the dispersion grating 5, the first order diffracted light is dispersed from the dispersion grating 5, the diffracted light is then focused on the liquid crystal pixel mirror 70 by the focusing lens 6. Different wavelengths of light focus on different positions, every pixel of the liquid crystal pixel mirror 70 is corresponding to different wavelength of light. The reflected light of every pixel of the liquid crystal pixel mirror 70 coming back to the semiconductor laser 1 following the original route to form resonant output. By controlling the magnitude of the driving voltage of the liquid crystal cell 40, the director of the liquid crystal molecular can be reoriented, which causes the variation of the phase, then changes the optical path, which means the cavity length is changed, so that the output wavelength of the laser can be tuned.

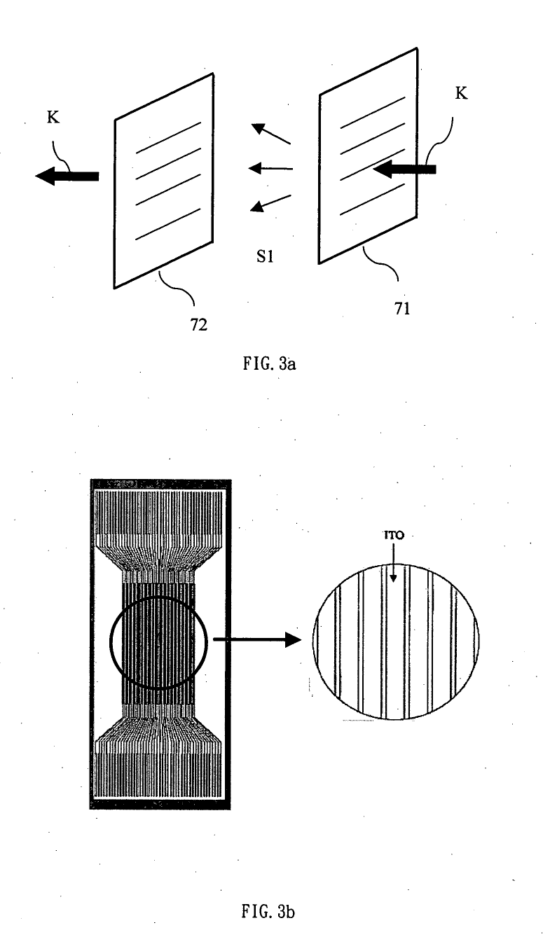

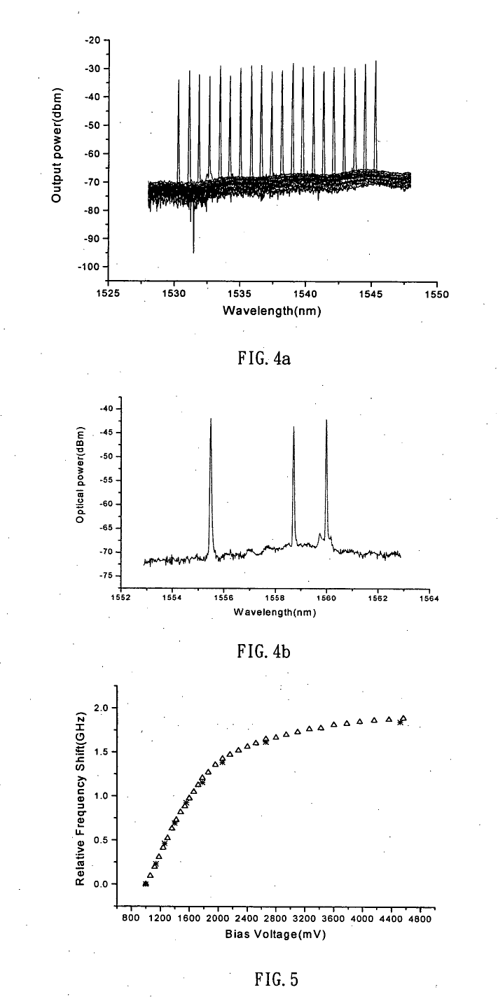

FIG. 2, FIG. 3(A) and FIG. 3(B) illustrate the composition of the liquid crystal cell 40, the liquid crystal pixel mirror 70 and the ITO pattern of the liquid crystal pixel mirror. FIG. 4 and FIG. 5 illustrate the experiment results of a practical electrically tuned multi-wavelength external-cavity laser of the present invention.

As shown in FIG. 2, liquid crystal cell 40 is composed by two glass plates 41 and 42 filled with nematic liquid crystal L1, and the rubbing direction of the glass plates are parallel to each other. The two ends of the liquid crystal cell 40 are wound with conductive tapes E1, by applying voltage to the liquid crystal cell 40, the liquid crystal molecular will rotate which causes the variation of the phase. The liquid crystal cell 40 is installed in the cavity of the laser, which causes the cavity length to change so that the output wavelength of the laser will be changed.

As shown in FIG. 3(A), liquid crystal pixel mirror 70 is composed by two glass plates 71 and 72 filled with twisted nematic liquid crystal L2, and the rubbing direction of the glass plates are perpendicular to each other. S1 is the direction of the liquid crystal molecular when the driving voltage is applied. K is the direction of the incident light. On the surface of the glass plate 71 ITO pattern is coated to form pixels. Every pixel can be electrically controlled individually. Separately control the driving voltage of the liquid crystal of each pixel can switch each pixel independently to select the transparent or not transparent of light. The back surface of the glass plate 72 is covered with a gold reflected mirror M and a polarizer P, the beam passed through then focusing on the gold reflected mirror M, the reflected light coming back along the original path to form oscillation and produce laser output.

As shown in FIG. 3(B), the ITO pattern of the liquid crystal pixel mirror 70 is vertically spacing stripes on the inner side of the glass plate 71, which forms the long strip pixels.

As shown in FIG. 4(A), the electrically tuned multi-wavelength external-cavity laser of the present invention, by individually control the voltage of the pixel on the liquid crystal pixel mirror 70 to selectively switching different pixels, so that the output frequencies of the laser have 100 GHz spacing. The x-axis is the output wavelength of the laser. The y-axis is the output power. There are 20 different output frequencies.

As shown in FIG. 4(B), the electrically tuned multi-wavelength external-cavity laser of the present invention, FIG. 4(B) shows the output by opening three different pixels of the liquid crystal pixel mirror 70 arbitrarily. The x-axis is the output wavelength of the laser. The y-axis is the output power. There are 3 different frequencies output in the same time.

As shown in FIG. 5, the electrically tuned multi-wavelength external-cavity laser of the present invention, by changing the voltage of the liquid crystal cell 40, the frequency of the laser can be changed. The x-axis is the voltage of the liquid crystal cell 40, and the y-axis is the relative frequency shift. In the figure, Δ is the experiment value and * is calculated theoretical value.

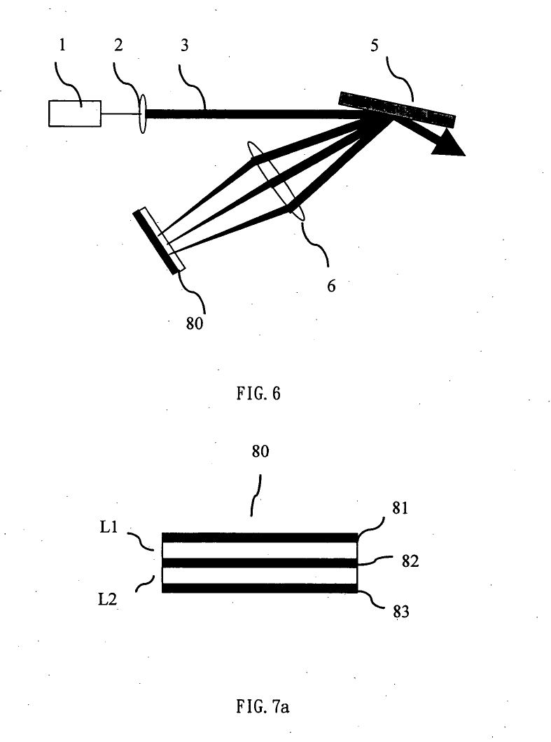

As shown in FIG. 6, the electrically tuned multi-wavelength external-cavity laser of the present invention, the liquid crystal cell 40 and the liquid crystal pixel mirror 70 as shown in FIG. 1 can be replaced by a sandwich-type liquid crystal pixel mirror 80.

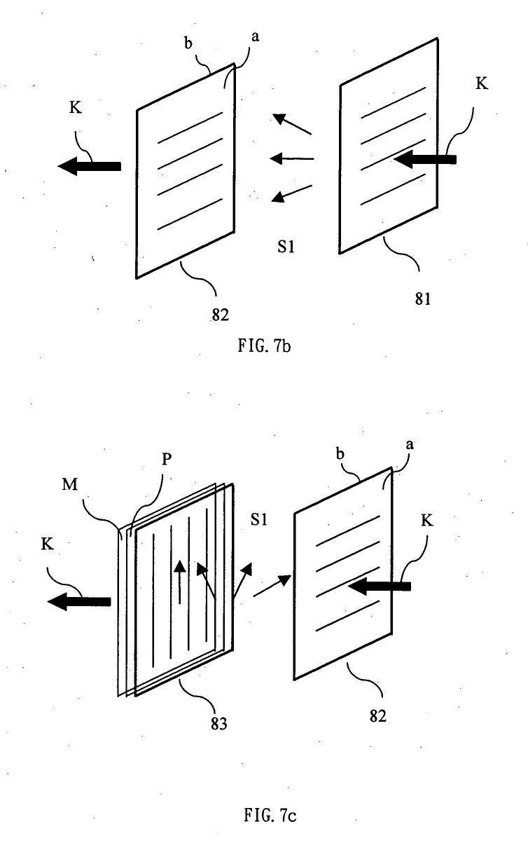

FIG. 7(A), FIG. 7(B) and FIG. 7(C) illustrate the composition of the sandwich-type liquid crystal pixel mirror 80.

As shown in FIG. 6, the electrically tuned multi-wavelength external-cavity laser of the present invention comprising: an AR-coated seniconductor diode laser 1, a collimator 2, a dispersion grating 5, a focusing lens 6 and a sandwich-type liquid crystal pixel mirror 80. The light emitted from the semiconductor laser 1 goes through the collimator 2, forms a collimated laser beam 3, laser beam 3 hits the dispersion grating 5, the incident collimated laser beam is diffracted by the dispersion grating 5, the first order diffracted light is then focused on the sandwich-type liquid crystal pixel mirror 80 by the focusing lens 6. Different wavelengths of light focus on different positions, every pixel of the sandwich-type liquid crystal pixel mirror 80 corresponds to different wavelength of light. The reflected light of every pixel of the sandwich-type liquid crystal pixel mirror 80 comes back to the semiconductor laser 1 following the original route to form resonant output. The sandwich-type liquid crystal pixel mirror 80 is a double layer structure composed by a phase-tuned liquid crystal pixel plate and a liquid crystal pixel mirror. The voltage of each layer can be controlled independently, and the voltage of every pixel can be controlled individually.

As shown in FIG. 7(A), the sandwich-type liquid crystal pixel mirror 80 is composed by three glass plates 81, 82 and 83, and filled with liquid crystal L1 and L2 to form a structure like a sandwich.

As shown in FIG. 7(B), between glass plates 81 and 82, filled with nematic liquid crystal L1, and the rubbing direction of back surface of glass plate 81 and surface a of glass plate 82 are parallel to each other. ITO pattern is coated on surface a of glass plate 82 to form the pixels. Every pixel can be electrically and separately controlled. The wavelength of the laser corresponding to each pixel can be continuously tuned by varying the driving voltage. Where S1 is the direction of the liquid crystal molecular and K is the direction of the incident light.

As shown in FIG. 7(C), between glass plates 82 and 83, filled with twisted nematic liquid crystal L2, and the rubbing direction of surface b of glass plate 82 and the front surface of glass plate 83 are perpendicular to each other. Where S1 is the direction of the liquid crystal molecular and K is the direction of the incident light. ITO pattern is coated on surface b of glass plate 82 to form the pixels. Every pixel can be electrically and separately controlled. Each pixel can be addressed so that it is opaque to light. A polarizer P and a high reflector, e.g. a gold reflected mirror M are attached to the back surface of the glass plate 83, the beam passed through then focusing on the gold reflected mirror M, the reflected light coming back along the original path to form oscillation and produce laser output.

Although specific embodiments of the invention have been disclosed, the specification and drawings are, accordingly, to be regarded as an illustration rather than a restrictive sense. It will, however, be understood by those having skill in the art that minor changes can be made to the form and details of the specific embodiments disclosed herein, without departing from the spirit and the scope of the invention.

The embodiments presented above are for purposes of example only and are not to be taken to limit the scope of the appended claims.

1. An electrically tuned multi-wavelength external-cavity laser, comprising:
an AR-coated diode laser;
a collimator, to form a collimated laser beam;
a liquid crystal cell, formed by two glass plates and filled with nematic liquid crystal, the two ends are wound with conductive tapes for applying and changing the driving voltage to the liquid crystal cell to tune the output wavelength of the laser;
a dispersion grating, to produce diffraction and dispersion of the incident collimated laser beam;
a focusing lens, to focus the dispersed light on a liquid crystal pixel mirror;
a liquid crystal pixel mirror, formed by two glass plates and filled with twisted nematic liquid crystal, the rubbing direction of the glass plates with ITO pixel patterns are perpendicular to each other; the wavelength of the laser can be switched by switching on-off the driving voltage of the appropriate pixel.

2. An electrically tuned multi-wavelength external-cavity laser as recited in claim 1, wherein said driving voltage of said liquid crystal pixel mirror can be controlled separately to select the appropriate pixel of a single or multi-wavelength of laser output.

3. A electrically tuned multi-wavelength external-cavity laser, comprising:
an AR-coated diode laser;
a collimator, to form a collimated laser beam;
a dispersion grating, to produce diffraction and dispersion of the incident collimated laser beam;
a focusing lens, to focus the dispersed light on a liquid crystal pixel mirror;
a sandwich-type liquid crystal pixel mirror, formed by a first, a second and a third glass plates and filled with first a layer of nematic liquid crystal and second a layer of twisted nematic liquid crystal, the rubbing direction of the back surface of the first glass plate is parallel to the rubbing direction of the front surface of the second glass plate, the rubbing direction of the back surface of the second glass plate which is parallel to the rubbing direction of its front surface is perpendicular to the rubbing direction of the front surface of the third glass plate, both the surfaces of the second glass plate have ITO pixel patterns, every pixel can be electrically controlled, laser wavelength can be tuned by varying the driving voltage applied to the pixel on the front surface of the glass plate which causes the phase change, control each pixel on the back surface of the glass plate to select the output wavelength of the laser, the back surface of the third glass plate is covered with a gold reflected mirror and a polarizer, the beam passed through then focusing on the gold reflected mirror, the reflected light coming back along the original path to form oscillation and produce laser output.

4. An electrically tuned multi-wavelength external-cavity laser as recited in claim 3, wherein said first layer of liquid crystal is nematic liquid crystal.

5. An electrically tuned multi-wavelength external-cavity laser as recited in claim 3, wherein said second layer of liquid crystal is twisted nematic liquid crystal.

6. An electrically tuned multi-wavelength external-cavity laser as recited in claim 3, wherein said driving voltage of said nematic liquid crystal can be controlled separately.

7. An electrically tuned multi-wavelength external-cavity laser as recited in claim 3, wherein said driving voltage of said twisted nematic liquid crystal can be controlled separately.

8. An electrically tuned multi-wavelength external-cavity laser as recited in claim 3, wherein said driving voltage of said every pixel of said nematic liquid crystal can be controlled individually.

9. An electrically tuned multi-wavelength external-cavity laser as recited in claim 3, wherein said driving voltage of said every pixel of said twisted nematic liquid crystal can be controlled individually.
